(19) United States
(12) Patent Application Publication
(10) Pub. No.: US 2016/0125451 A1
(43) Pub. Date: May 5, 2016

(54) ASSET SUGGESTIONS FOR ELECTRONIC POSTS

(71) Applicant: ADOBE SYSTEMS INCORPORATED, San Jose, CA (US)

(72) Inventors: Mohit Garg, New Delhi (IN); Ankur Jain, Uttar Pradesh (IN)

(73) Assignee: ADOBE SYSTEMS INCORPORATED, San Jose, CA (US)

(21) Appl. No.: 14/532,203

(22) Filed: Nov. 4, 2014

(51) Int. Cl. G06Q 30/02; G06Q 50/00

(52) U.S. Cl. CPC G06Q 30/0243; G06Q 30/0269; G06Q 50/01

(57) ABSTRACT

Techniques are disclosed for improving electronic communications or so-called posts prior to publication by automatically providing asset suggestions. The techniques generally leverage known historical performance data of rich media “assets” such as image content, graphics content, video content, and audio content. In operation, an asset repository is searched to identify a set of candidate assets that match keywords extracted from a proposed post. The identified candidate assets are ranked based on their performance in one or more target user segments associated with the target audience of post. The post can then be modified to include one or more of the ranked assets. In one example case, the ranked assets are provided to the user, so that the user can select one or more of the ranked assets for incorporation into the post.

### FIELD OF THE DISCLOSURE

This disclosure relates to digital content publishing, and more particularly, to techniques for improving electronic posts such as social media and marketing posts prior to publication by providing asset suggestions based on past performance across one or more digital channels.

### BACKGROUND

Online social media generally refers to Internet-based applications that allow individuals and so-called online communities to create, exchange, modify, and/or discuss user-generated content. The extension of social media applications to mobile computing devices effectively enables highly interactive media platforms through which communications can reach large numbers of potentially interested persons in a rapid fashion, thereby making social media applications a dominant media outlet. The online social networks that are generated through the use of such social media applications have grown to be particularly important to marketers, whether they be selling products, services, or personal image (e.g., celebrities and so-called online personas). For example, it is not uncommon for marketers to make announcements, run promotions and interact with consumers using such applications. Social networking services, such as Facebook and Twitter, are particularly important to marketers and advertising entities, and as a result, such networks frequently play an important role in modern marketing campaigns. Indeed, marketers often devote substantial resources to influencing and monitoring consumer sentiment across social networks.

### BRIEF DESCRIPTION OF THE DRAWINGS

FIG. 1 illustrates architecture for a communication network configured in accordance with an embodiment of the present invention.

FIG. 2 illustrates example input and output of an asset suggestion module configured in accordance with an embodiment of the present invention.

FIG. 3a is a block diagram of an asset suggestion module configured in accordance with an embodiment of the present invention.

FIG. 3b illustrates an asset repository configured in accordance with an embodiment of the present invention.

FIG. 4a illustrates a methodology for making pre-post asset suggestions, in accordance with an embodiment of the present invention.

FIG. 4b illustrates a methodology for ranking candidate assets such as those identified in the methodology of FIG. 4a, in accordance with an embodiment of the present invention.

FIGS. 5a-b collectively illustrate an example user interface configured for use with a pre-post asset suggestion methodology, in accordance with an embodiment of the present invention.

### DETAILED DESCRIPTION

Techniques are disclosed for improving electronic communications or so-called posts prior to publication by automatically providing asset suggestions. The techniques generally leverage known historical performance data of rich media “assets” such as image content, graphics content, video content, and audio content. For example, assume a proposed post includes some type of content, such as text, images, and/or video. Further assume that the post is intended for a given target audience, and that there is a target business metric that the publisher or “marketer” hopes to maximize within that target audience. In any case, keywords are extracted from the proposed post and are used to query a database to identify candidate assets. In addition, target user segments can also be determined, based on the target audience of the post. An asset repository can then be searched to identify a set of assets that match the keywords extracted from the post. The identified set of assets can then be ranked based on their performance in the target user segments of the post. The ranked assets can then be provided to the user, so that the user can select one or more of the ranked assets for incorporation into the post. Alternatively, the highest ranked asset(s) can be automatically incorporated into the post. The techniques can be implemented on a user's computer system as an application feature or a stand-alone application or plugin. Likewise, the techniques can be implemented in the context of a client-server arrangement where at least one of the client and server computing systems are programmed or otherwise configured to carry out the methodology. Numerous configurations will be apparent in light of this disclosure.

General Overview

As previously indicated, marketers often devote substantial resources to influencing and monitoring consumer sentiment across social networks. In the context of online social media, marketers attempt to create content for engaging a target audience and to meet business goals as part of a given social media strategy. Currently, there is no way for social media marketers to receive suggestions on how to improve their content, prior to publication of that content, with the objective of optimizing target business metrics. In a more general sense, there is no scientific way for a social media marketer to know in advance of publication if the right content (e.g., text, images, graphics, etc) is being used in a proposed social media post to meet given business goals. Exacerbating this situation is that social media content is increasingly becoming more and more visual, in that the user of rich media assets is becoming more common. Thus, social media marketers are at best reconciled to manually sift through hundreds of potential rich media assets in effort to determine which one(s) are suitable for the content in a given social media post, and are likely to perform well. Moreover, there is no scientific basis for this manual selection process, which is usually based on “gut-feel” or “experience” of the content author. Such non-scientific bases are oftentimes completely divorced from the relevant realities associated with the target audience, marketing channel, and business goals, and in any case subject the published content to over-exposure typical of trial-and-error marketing campaigns where the power of first impression diminishes greatly after the first variant of the content is published.

Thus, and in accordance with an embodiment of the present invention, a publication system is programmed or otherwise configured to provide asset suggestions suitable for a proposed post, based on past performance of the various assets on various digital channels. For example, assume a proposed social media or marketing post includes some type of content, such as text, images, and/or video. Further assume that the post is intended for a given target audience, and that there is a target business metric that the marketer hopes to maximize within that target audience. In any case, the proposed post is analyzed so that appropriate assets can be suggested. In particular, a keyword extraction process is used to extract keywords out of the post. In addition, target user segments can also be determined, based on the target audience of the post. For example, the target audience of males in the age range of 18-25 that live California has three distinct user segments: gender, age, and location. An asset repository can then be queried or otherwise searched to identify a set of assets (e.g., images, videos, graphics, and audio clips) that match the keywords extracted from the post. The identified set of assets can then be ranked based on their performance in the target user segments of the post. The ranked assets can then be provided to the user, so that the user can select one or more of the ranked assets for incorporation into the post. Alternatively, the highest ranked asset(s) can be automatically incorporated into the post. In some such cases, the user may be given opportunity to adjust the placement of the auto-selected assets.

In some embodiments, the score of each asset is based on two distinct metrics for each time that asset has been deployed in the past. The first metric generally refers to the segment score of the candidate asset, and is a measure of how well the segment(s) of that asset intersect with the segments in the target audience. An asset deployment that matches all the user segments of the target audience gets a higher score as compared to an asset which only matches with one or none of the target audience user segments. A segment score of zero indicates that none of the candidate user segments match with the asset deployment user segments. The second metric generally refers to the performance score of the candidate asset, and is a measure of how well that asset performed with respect to the target business metric of the proposed post. These two scores can be used to effectively rate the success of each deployment of a given candidate asset, and each such rating can in turn can be used to provide an overall score for that candidate asset. In one example such embodiment, the rating of each deployment is the product of the two scores (segment score×performance score), and the overall score for that candidate asset is the sum of the products. Each candidate asset in the identified set can then be ranked accordingly. Numerous variations and ranking schemes will be apparent in light of this disclosure.

The target business metric may be, for example, one of reach, engagement, or conversion, depending on how deep the marketer expects the post to impact the target audience. In particular, reach refers to the number of people actually reached in the target audience, engagement refers to the number of people reached that actually engage with the post (e.g., by clicking a link or play video), and conversion refers to the number of people that engage with the post and actually take some action to bring about a desired business outcome (e.g., sign-up, purchase, provide information, etc). Any number of target business metrics can be used, as will be appreciated. As long as the proposed post has a target business metric, a given candidate asset can be analyzed for that particular metric.

The structure of the asset repository can be configured to facilitate the identification and scoring of assets. In one example embodiment, the asset repository stores assets that can be used across various digital marketing channels. In addition, the repository may further store metadata associated with each asset. In some such embodiments, the metadata could include, for example, the following: keywords, tags, and the date last used for each asset. The repository can be searched based on any number of indices. In one example case, the repository is indexed by the keywords for each asset stored therein. So, for instance, each asset record can include the asset itself (or its location, so that it can be accessed), keywords, and deployment data (or the location of that deployment data). The deployment data could include, for instance, the target business metric, channel, and target audience for each deployment of a given asset stored in the repository. Thus, given one or more keywords and one or more target audience sectors associated with a proposed post, the repository can be queried to identify the various relevant records associated with candidate assets having the one or more keywords and performance data with respect to the target business metric. Any number of database structures and management systems can be used to implement, populate, and access the repository, and the present disclosure is not intended to be limited to any particular types. Example structures include look-up tables indexed by keywords, linked lists, relational databases, XML databases, hierarchical databases, or object-oriented databases, to name a few.

The techniques may be implemented in any number of ways, as will be appreciated in light of this disclosure. For instance, in one example case, the techniques may be implemented as an independent asset suggestion module or plugin that monitors outgoing posts for one or more applications that operate on the given computing platform. In one such case, the module may be a plugin that operates in conjunction with the local browser application that a user (marketer) can employ to access various social media websites (e.g., Twitter, Facebook, LinkedIn, etc). Alternatively, the techniques may be integrated directly within a comprehensive social media application or platform or service, such as Adobe Social. By collecting and storing assets as well as performance of those assets across multiple digital channels, suitable assets can be identified for a proposed post based on keywords and target audience for that post. The assets that best match the post can then be recommended for integration with the post to optimize the target business metric (e.g., reach, engagement, or conversion). Numerous variations will be apparent in light of this disclosure.

One example embodiment provides a client-side asset suggestion system configured to make asset recommendations for proposed posts and other postable digital content. As will be appreciated, the disclosed techniques can be used to provide marketers a way to create content and maximize alignment with a given target business metric around a given topic, prior to publishing. As will further be appreciated, a marketer can be anyone or any entity interested in publishing content. It is typically desirable that the published content is favorably received by a given target audience, whether that marketer is providing goods/services (e.g., commercial entities), information (e.g., news organizations, commentators, or individuals that may wish to publish digital content), and professional image (e.g., politicians, comedians, celebrities). The marketer can also be anyone who may benefit from having a well-regarded or otherwise followed online presence.

A target audience, in addition to its plain and ordinary meaning, generally refers herein to one or more persons or groups or organizations or combinations thereof that a marketer is attempting to reach with one or more posts. In a more general sense, a target audience refers to any such entities that may be interested in given content. A post, in addition to its plain and ordinary meaning, generally refers herein to any digital communication that can be electronically published to an online network or location. The post may include textual content, graphical content, photo or image content, video content, audio content, or any combination thereof. In a more general sense, a post may include any digital content that can be published. A post may also include, for example, content in a physical form (e.g., paper, film, photograph, etc) that has been electronically analyzed as provided herein. A marketer, in addition to its plain and ordinary meaning, generally refers herein to any person, group, organization, or combinations thereof that wish to publish content.

Such pre-post asset selection guidance may be useful, for example, to a marketer wishing to positively connect with or otherwise impact a target audience having a measurable reaction to asset-based content. In some embodiments, an automatic asset recommendation with respect to a proposed post saves time and resources of the marketer. A post containing one or more recommended assets that are battle-tested for a given target audience and business metric is more likely to resonate or influence the target audience. Numerous benefits will be apparent in light of this disclosure.

System Architecture

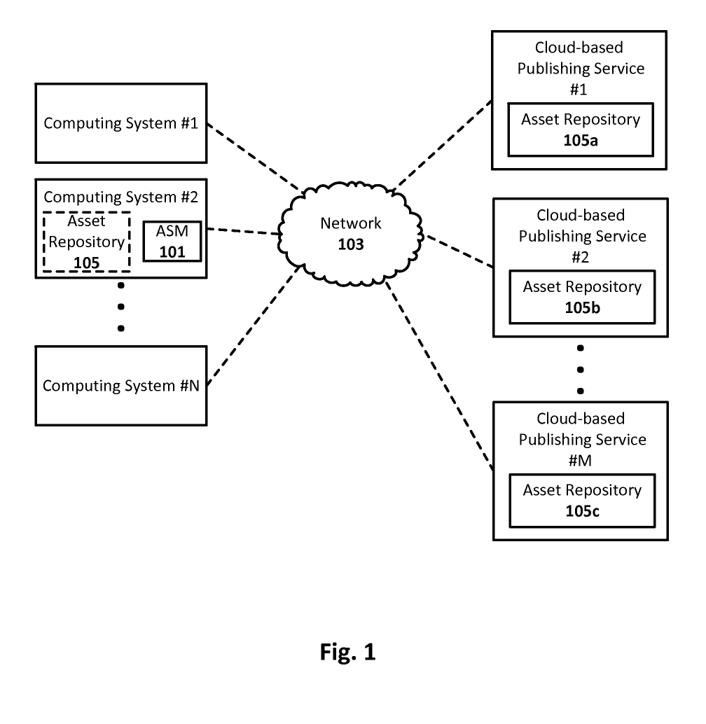

FIG. 1 illustrates architecture for a communication network configured in accordance with an embodiment of the present invention. As can be seen, the architecture includes a number of computing systems (#1 through #N) each capable of operatively coupling to a number of cloud-based publishing services (#1 through #M) via a communication network 103. Each of the publishing services includes or otherwise provides access to an asset repository (105a, 105b, 105c, etc). In operation, a given user can use a corresponding one of the N computing systems to access any one or more of the M publishing services and post digital content to that system(s). As can be further seen, computing system #2 includes an asset suggestion module (ASM) 101, which is programmed or otherwise configured to assist the user in making asset selection decisions in accordance with an embodiment of the present invention. In particular, the user of computing system #2 can receive, via the ASM 101, asset recommendations identified as suitable for a proposed post based on keywords extracted from the post. The identified candidate assets are ranked based on performance of those candidate assets in one or more user segments of the target audience for that proposed post. The post may include, for example, text, a photo or image, video, audio, or some combination thereof. Non-textual content contained in images or video can be extracted using conventional image processing and sound-to-text translators to create an appropriate text string that can then be processed in a similar manner to text-based posts for purposes of keyword extraction.

The publishing services may be, for example, any one or combination of social media applications (e.g., Facebook, Twitter, Instagram, LinkedIn, Tumblr, Flipboard, etc), blogs and information boards and news sites (e.g., HuffingtonPost, Mashable, Gawker, BusinessInsider, The Daily Beast, CNN, etc), video upload sites (e.g., YouTube, MySpace videos, DailyMotion, MetaCafe, iPikz, etc) or any other systems that allow for publishing and viewing of digital content.

The asset repository 105 of each publishing system may include any type of digital content such as, for example, user generated content, news stories, articles, images, photos, audio clips, and/or videos, and is accessible for consumption by other users having access to that publishing system. As will be further appreciated, the network 103 can be any communication network or combination of networks (whether public and/or private, wired and/or wireless), such as a user's local area network and/or the Internet as is frequently the case, or a campus-wide network for a university or business. Each cloud-based publishing system may be implemented with any suitable type of architecture, and may include one or more servers under the control of one or more entities (e.g., a single server, a server farm, multiple server farms, etc). Numerous configurations that allow for publication of user generated digital content (posts) can be used and the present disclosure is not intended to be limited to any particular server system or back-end configuration.

The computing systems can be implemented with any typical computing technology, such as a desktop, laptop, work station, tablet, smart phone, smart camera, or other computing system than allows for generation of user content and is capable of posting that content to a publishing service via a network. Such computing systems will generally include one or more processors capable of executing software modules stored in one or more memories accessible by that processor(s), or other functional componentry that is configured to carry out typical computing system functionality. In addition, and as will be appreciated in light of this disclosure, any such systems can be programmed or otherwise configured with an ASM 101 to carry out pre-post asset suggestion functionality as provided herein. While a plurality of both computing systems and publishing services are shown in the example embodiment of FIG. 1, other embodiments may include, for example, only one of each, or multiple computing systems capable of operatively coupling to a single publishing service, or a single computing system capable of operatively coupling to multiple publishing service services. Further note that only one post moderating module 101 is shown in the example embodiment depicted in FIG. 1, but any number of the N computing systems may be programmed or otherwise configured with an ASM 101.

As can be further seen in FIG. 1, computing system #2 may also be programmed or otherwise configured with a self-contained asset suggestion system as provided herein, wherein not only does the computing system include an ASM 101 but further includes an asset repository 105. Note that such a self-contained configuration need not communicate with a network or otherwise access a remote database of assets. In one such embodiment, the ASM 101 module (or the asset repository 105 itself), may be configured to periodically crawl various remote asset databases available via network 103 so as to populate, update, or otherwise refresh the local asset repository 105.

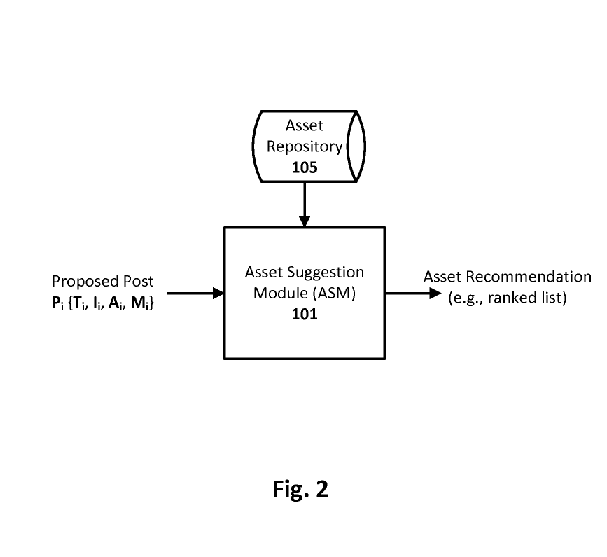

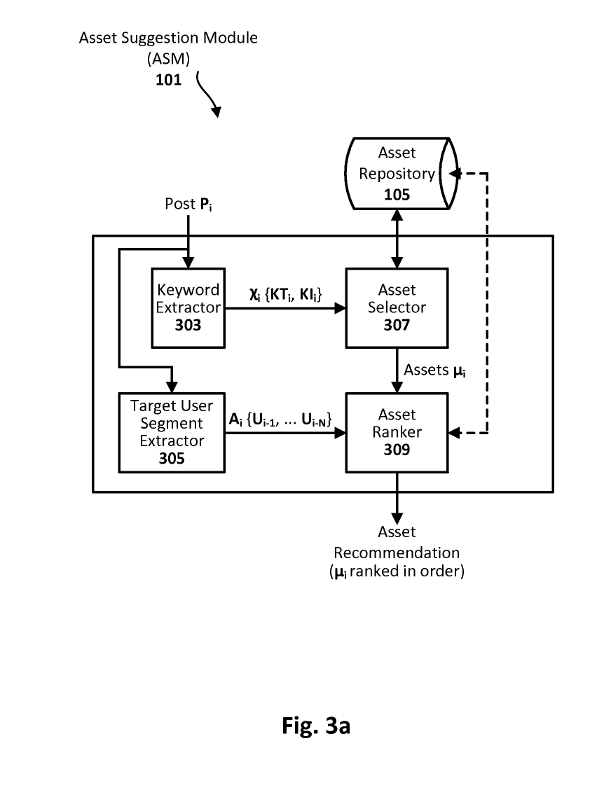

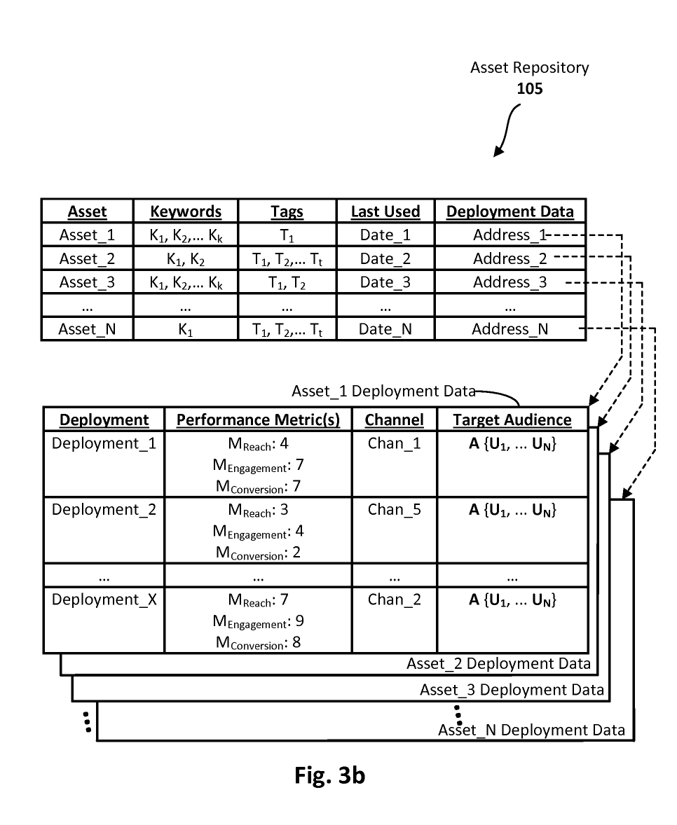

FIG. 2 illustrates example input and output of an asset suggestion module 101, in accordance with an embodiment of the present invention. As can be seen, the ASM 101 is configured to receive a proposed post Pᵢ, which generally refers to some user generated content (e.g., an article or news story or a link thereto, an advertisement or a link thereto, a Twitter Tweet, a Facebook post, a blog post, a video, a photo, or any other digital content to be published). The proposed post Pᵢ may include, for example, some text Tᵢ, and optional image/video Iᵢ. In addition, the post may include or otherwise be associated with a target audience Aᵢ, and a metric Mᵢ which is the target business metric that the marketer (publisher, user, etc) wants to maximize. This business metric could be, for example, one of reach, engagement, or conversion, as previously explained. One specific embodiment effectively breaks down asset performance into an index with three parts—reach, engagement, and conversion, each of which can be scored separately based on some established criteria or thresholds commensurate with performance goals. Further details with respect to such an embodiment are provided with reference to FIG. 3b.

In addition, the ASM 101 is further configured to access the asset repository 105 to identify one or more previously deployed assets having one or more keywords extracted from the proposed post Pᵢ. The list of assets resulting from the keyword search of the asset repository 105 is generally referred to as the list of candidate assets for the given post Pᵢ. With the list of candidate assets in hand, the ASM 101 is further configured to rank each of those candidate assets based on how well they intersect with the various user segments associated with the target audience of post Pᵢ. Based on the results of that intersection analysis, the ASM 101 is further configured to provide the would-be publisher/user content selection guidance or a recommendation. Further details of the ASM 101 will be discussed with reference to FIGS. 3a-5b.

As will be further appreciated in light of this disclosure, the asset repository 105 includes assets associated with or otherwise previously deployed (published) in the context of a given audience, which effectively provides the target audience of anyone considering publishing content into that existing body of work. For instance, a blog about poetry would be frequented by people interested in poetry whom collectively provide the target audience of anyone posting to that blog. Similarly, an online social network of a given user typically includes friends, family, acquaintances, and/or so-called followers/friends/contacts of that user, which effectively provides a target audience for that user. Similarly, an online technology network (e.g., Institute of Electrical and Electronics Engineers, American Society of Civil Engineers, etc) where scientists or engineers can publish white papers, presentations, and other technical papers would be frequented by people interested in a given area of technology who collectively provide the target audience of anyone posting to that network. In a more general sense, any online network or community typically includes a number of subscribers, followers, and/or other persons that have indicated in one way or another an interest in subject matter associated with that community and collectively provides a target audience for future posters that wish to publish content to that network/community.

In some embodiments, the ASM 101 can be configured to crawl various relevant storage location(s) accessible via a network (e.g., the Internet) where existing published assets are located, and to save those assets and their corresponding metadata to the content repository 105. In an embodiment, the metadata includes keywords of that asset extracted and the target business metric performance data for each deployment of that asset. Storage of a given assets and its metadata can be restricted for the content is protected or otherwise inappropriate to copy. In other embodiments, the content repository 105 can be populated and organized by keywords by a third-party and then provided to the ASM 101 in a desired format, such as by a server-side asset suggestion tool. In a more general sense, the collection of assets in content repository 105 can be obtained using any number of conventional or customized data harvesting and keyword-based aggregation techniques, and the present disclosure is not intended to be limited to any particular such technique or set of techniques. Once the content repository 105 is populated or otherwise made accessible, the ASM 101 can then assess the assets within the repository 105 to determine the keyword-based list of candidate assets that correlate to the keywords extracted from the post, and can further rank those candidate assets based on their respective deployment performances in the target audience of post Pᵢ.

Asset Suggestion Module

FIG. 3a is a block diagram of an asset suggestion module 101 configured in accordance with an embodiment of the present invention. As can be seen, the ASM 101 is configured with a number of sub-modules or components, including a keyword extractor 303, a target user segment extractor 305, an asset selector 307, and an asset ranker 309. Other embodiments may include a different degree of integration or modularity, and the example depicted is provided to facilitate discussion and not intended to limit the functionality provided herein to a particular architecture. For instance, in other embodiments, the keyword extractor 303 and the target user segment extractor 305 may be integrated into a common module that provides comparable functionality. Numerous other configurations will be apparent in light of this disclosure.

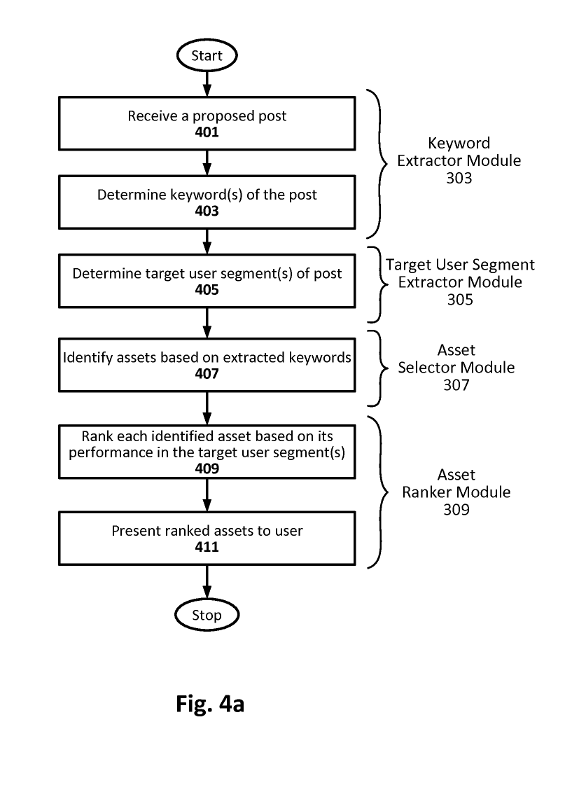

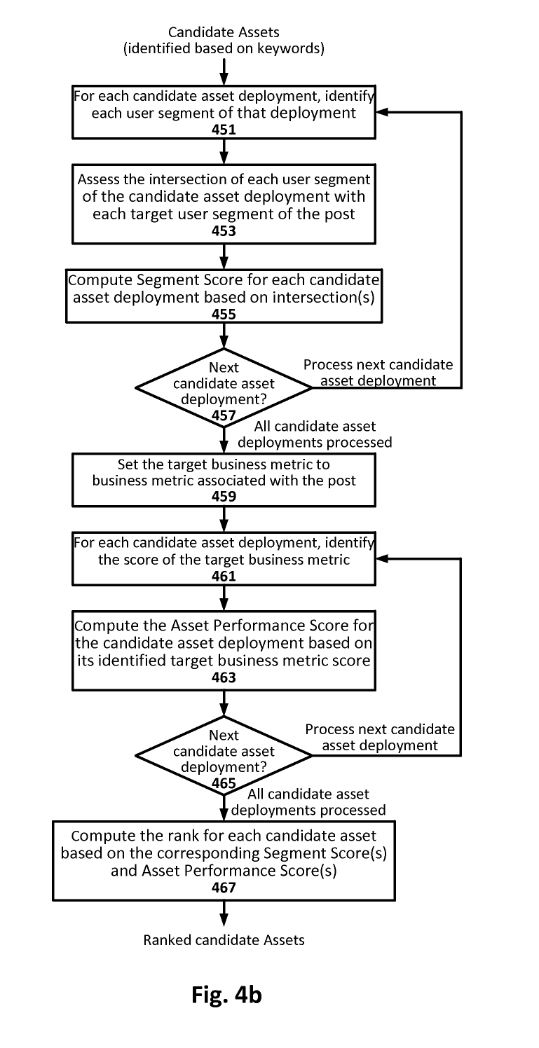

In operation, the keyword extractor 303 is programmed or otherwise configured to receive a proposed post Pᵢ, and to extract keywords associated with that post Pᵢ. As previously explained, a typical post Pᵢ may include, for example, some text Tᵢ, and optional image/video Iᵢ. In addition, assume the post includes or is otherwise be associated with a target audience Aᵢ, and a target business metric Mᵢ. In addition, the target user segment extractor 305 is programmed or otherwise configured to extract the target user segments Uᵢ based on the target audience Aᵢ, of the post. As can be seen, the extraction process results in a list of keywords χᵢ denoted by the set {KTᵢ,KIᵢ} as well as a list of target user segments denoted by the set Aᵢ{Uᵢ₋₁, . . . U_{i-N}}. In particular, keywords extracted from the text Tᵢ are denoted as KTᵢ, and keywords extracted from the image/video Iᵢ are denoted as KIᵢ. With respect to extracted target user segments, if the target audience Aᵢ={Males, 18-25, California}, for instance, then there are three target user segments that can be extracted or otherwise identified: U_{i-gender}=Male; U_{i-age}=18-25 and U_{i-location}=California. The asset selector 307 is programmed or otherwise configured to receive the set of keywords χᵢ{KTᵢ, KIᵢ}, and to query the asset repository 105 to identify candidate assets μᵢ that are associated with those keywords. The asset ranker 309 receives that candidate asset set μᵢ and is programmed or otherwise configured to rank each candidate asset based on historical deployment data associated with that asset. In particular and in accordance with an embodiment, for each deployment of a given candidate asset, the asset ranker 309 generates a segment score that indicates the intersection of each user segment of that asset with the user segments in the target audience, and further generates a performance score that indicates a measure of how well that asset performed with respect to the target business metric of the proposed post. These two scores can be used to effectively rate the success of each deployment of a given candidate asset, and each such rating can in turn can be used to provide an overall score for that candidate asset. For instance, in one example case, the two scores are multiplied to provide an individual deployment score, and then all of the deployment scores for that asset are summed together to provide an overall score. Other scoring schemes can be used as well, as will be appreciated in light of this disclosure. In any case, each candidate asset is assigned an overall score and can then be ranked accordingly. The ranked assets can then be presented to the user for selection and incorporation into the post, such as the example case where the top three ranked asset are displayed to the user. In other embodiments, the top one to three candidate assets (or some subset of candidate assets) can be automatically integrated with the post (e.g., by the asset ranker or other module). Further details of how these functional modules operate and how they can be implemented in some example embodiments will be provided with reference to FIGS. 4a-b and 5a-b.

Each of the various components can be implemented in software, such as a set of instructions (e.g., C, C++, object-oriented C, JavaScript, Java, BASIC, etc) encoded on any computer readable medium or computer program product (e.g., hard drive, server, disc, or other suitable non-transient memory or set of memories), that when executed by one or more processors, cause the various asset suggestion methodologies provided herein to be carried out. In other embodiments, the functional components/modules may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number of embedded routines for carrying out the asset suggestion functionality described herein. In a more general sense, any suitable combination of hardware, software, and firmware can be used.

In one example embodiment, each of the keyword extractor 303, target user segment extractor 305, asset selector 307, and asset ranker 309 is implemented with JavaScript or other downloadable code that can be provisioned in real-time to a client computing system requesting access (via a browser) to an application server hosting an online publishing venue of interest. In another example embodiment, each of the keyword extractor keyword extractor 303, target user segment extractor 305, asset selector 307, and asset ranker 309 is installed locally on the user's computing system, as a pre-post guidance or asset suggestion system. In still another embodiment, the ASM 101 can be partly implemented on client-side and partly on the server-side. For example, each of the keyword extractor 303, target user segment extractor 305, asset selector 307, and asset ranker 309 can be implemented on the server-side (such as a server that provides access to, for instance, Adobe Social or a cloud-based marketing application), and a user interface (such as Adobe Social user interface or other suitable user interface) can be implemented on the client-side. Numerous such client-server arrangements will be apparent in light of this disclosure.

As will be further appreciated, the ASM 101 can be offered together with a given application (such as integrated with a social networking application or user interface, or with any application that allows for online publishing of digital content), or separately as a stand-alone module (e.g., plugin or downloadable app, such as a Facebook or Twitter Plugin or a smartphone app from the Apple store, or other code) that can be installed on a user's computing system to effectively operate as a gateway to outgoing posts for a given application or a user-defined set of applications or for all outgoing posts. Alternatively, the ASM 101 could be hosted as an online cloud-based service integrating any available third-party trending topic and content ideation solution. Numerous embodiments and specific configurations will be apparent in light of this disclosure.

In one specific example embodiment, for instance, the ASM 101 is integrated with the publishing block of the Adobe Social application provided by Adobe Systems Incorporated. In general, Adobe Social enables marketers to use social media data as an input to optimize interactions with their customers and prospects across all channels to achieve measurable business results. In one specific aspect, Adobe Social allows a marketer or user to publish posts to dozens or hundreds of social media pages in a relatively easy manner. In addition, Adobe Social allows custom audiences to be targeted based on, for example, demographic and geographic data to get the right text posts, images, videos, links, pictures and events to the right people at the right time. To this end, the ASM 101 could be used as part of the post creation process that is implemented within the Adobe Social platform, in accordance with one embodiment.

FIG. 3b illustrates an asset repository 105 configured in accordance with an embodiment of the present invention. As can be seen, the asset repository 105 of this example embodiment stores a plurality of N assets that can be used across one or more digital marketing channels. In addition to the assets themselves, the asset repository 105 also stores metadata corresponding to each asset, which in this example case includes keywords, tags, date last used, and deployment data. In the embodiment shown, the deployment data is provided as a separate record or set of records that can be found at the specified address included in the main record of the asset. Numerous other suitable organizational database structures will be apparent and the present disclosure is not intended to be limited to any particular type.

So, for any given asset, a record may be accessed that specifies the metadata itself or a location where the relevant metadata can be accessed or otherwise found. For instance, in the example embodiment of FIG. 3b, Asset_1 is associated with keywords K₁, K₂, . . . Kₖ and tags T₁, and was last used on Date_1. In addition, the deployment data associated with that asset can be found at Address_1. As can be further seen, a record or set of records can be found at Address_1 that specify information about X deployments for Asset_1. In particular, for each of those X deployments, an index of performance is provided. This index includes three business metrics (reach, engagement and conversion), and the performance score of the asset deployment for each of those metrics. A default score of zero can be assigned in cases where no relevant data is available or known for a particular business metric. For instance, for Deployment_1 of Asset_1 on Chan_1, the performance index indicates M_{Reach} of 4, M_{Engagement} of 7, and M_{Conversion} of 7 for the target audience A{U₁, . . . U_{N}}. Likewise, for Deployment_2 of Asset_1 on Chan_5, the performance index indicates M_{Reach} of 3, M_{Engagement} of 4, and M_{Conversion} of 0 for the target audience A{U₁, . . . U_{N}}. So, Asset_1 reached deeper into the target audience A via Chan_1 than did Asset_1 via Chan_5 (Deployment_2 did not generate any conversion, with M_{Conversion}=0). As will be appreciated, however, it is possible that Asset_1 may have fared better on Chan_5 with a different target audience, as another record in the asset repository 105 might indicate, depending on available data.

Methodology

FIG. 4a illustrates an asset suggestion methodology configured in accordance with an embodiment of the present invention. As can be seen, the methodology can be carried out by the ASM 101 discussed with reference to FIG. 3a, and the flow chart is annotated with the modules/components that can carry out each part of the flow. However, other embodiments may carry out the methodology using a different structure but still provide overall similar functionality.

The method includes receiving 401 a proposed post, and determining 403 one or more keywords of that post. The keyword extractor module 303 can carry out this function, or some other module(s). In more detail, given a proposed post Pᵢ, that includes some text Tᵢ, image/video Iᵢ (optional). Note that for images and video, a preliminary information extraction process can be carried out using, for instance, optical character recognition (OCR) and/or other conventional image processing techniques to extract information captured in the photo or video frames, including text and other detectable information in the images that can be translated into corresponding textual content. In addition, speech and sounds can be extracted from audio and video files and converted to text. In still other cases, tags embedded or otherwise associated with images, video, audio, and other types of non-textual content can be extracted or otherwise identified. Such tags are sometimes used, for example, by image classifiers, and can be equally informative in the context of the present disclosure. With the textual content available for analysis (whether that text was provided originally in textual format or derived from image processing and/or sound-to-text analysis and/or tags), any suitable keyword extraction algorithms can then be used to determine the keywords. Example keyword extraction algorithms that can be used include the term frequency—inverse document frequency (TF-IDF) algorithm, the keyphrase extraction algorithm (KEA), and the Maui Indexer, to name a few. The resulting set of keywords χᵢ is generally denoted by the set {KTᵢ, KIᵢ}.

The method further includes determining 405 one or more target user segments of the post Pᵢ. The target user extractor module 305 can be used to carry out this function, but other module(s) could be used as will be appreciated. In more detail, assume the post Pᵢ, identifies or is otherwise associated with a target audience Aᵢ. For example, if the target audience Aᵢ={Males, 18-25, California}, then the following target user segments can be extracted or otherwise determined: U_{i-gender}=Male; U_{i-age}=18-25 and U_{i-location}=California. Any suitable segmentation techniques can be used, including keyword extraction and analysis to identify the presence of user segment terminology (e.g., age, gender, location, likes, dislikes, hobbies, etc) and natural language processing.

With further reference to FIG. 4a, the method continues with identifying 407 one or more candidate assets that are appropriate for the given post Pᵢ. The asset selector module 305 can be used to carry out this function, but other module(s) could be used as will be appreciated. In particular, an asset database (e.g., such as content repository 105) can be queried or otherwise searched using the extracted keywords χᵢ. As will be appreciated, the database can be indexed by keywords to facilitate the search, but any suitable database structures can be used. Synonym translation can be used as well to effectively expand the set of search terms, as is sometimes done in search technology. The result of the query is a set of candidate assets (one or more images, videos, audio files, graphics, and/or other rich media content) that match or otherwise correspond to the set of keywords χᵢ derived from the post Pᵢ. This set is generally denoted by μᵢ.

The method continues with ranking 409 each identified candidate asset in set μᵢ, based on that asset's performance in the target user segments of the target audience Aᵢ (e.g., U_{i-gender}=Male; U_{i-age}=18-25 and U_{i-location}=California), and presenting 411 at least some of those ranked candidate assets for incorporation into the post. As previously explained, the user can review that ranked list of candidate assets and choose one or more assets for incorporation into the post Pᵢ. Alternatively, the highest ranked candidate asset (or assets, as the case may be) can be automatically integrated with the post. Note that the number of candidate assets that are actually used in the post can be user configurable, in accordance with some embodiments. Further details of the ranking process 409, in accordance with an example embodiment, will be provided with respect to FIG. 4b.

FIG. 4b illustrates a methodology for ranking candidate assets such as those identified in the methodology of FIG. 4a, in accordance with an embodiment of the present invention. The methodology includes: identifying 451 each user segment of a candidate asset deployment, assessing 453 the intersection of each user segment of that candidate asset deployment with each target user segment associated with the post Pᵢ, and computing 455 a segment score for that candidate asset deployment based on intersection(s). As can be further seen, each of the identifying 451, assessing 453, and computing 455 is repeated for each candidate asset deployment.

Once all the candidate asset deployments are associated with a segment score, the method continues with determining a performance score for each candidate asset deployment. In particular, the method continues with setting 459 the target business metric to the target business metric associated with the post Pᵢ. Then, for a given candidate asset deployment, the method includes: identifying 461 the score of the target business metric for that candidate asset deployment, and computing 463 the performance score for that candidate asset deployment based on the identified known target business metric score. In one example embodiment, the performance score for a given candidate asset is the score of the target business metric score for that asset. In another example embodiment, the target business metric score for each candidate asset can be scaled or otherwise normalized to provide the performance score for that candidate asset.

As can be further seen, each of the identifying 461 and computing 463 is repeated for each candidate asset deployment. Once all the candidate asset deployments are associated with a performance score, the method continues with computing 467 the rank for each candidate asset based on the corresponding segment score(s) and performance score(s) computed for that asset. In one embodiment, this can be, for example, a sum of the individual segment score(s) and performance score(s) for each deployment of a given candidate asset, as indicated here in Equation 1:

$$Asset Score = {\sum }_{All Asset Deployments} Segment Score * Performance Score$$

So, a total asset score can be computed, and the asset rankings can be based on their respect asset scores.

So, for a working example, assume a proposed post Pᵢ is: “Mario's pizza is the best snack for study breaks—only 2 miles from Major College. 10 Main Street, CollegeTown, India, call: 123-456-7890.” Further assume the target audience Aᵢ is college students within a 10 mile radius of Mario's location, including the main campus of Major College (e.g., Aᵢ={18-21, CollegeTown}. Further assume that the target business metric Mᵢ is conversion (e.g., pizza sales). Applying the methodology, in accordance with an embodiment, yields a set of keywords χᵢ extracted from the proposed post Pᵢ that includes pizza, snack, and college, and further yields a set of target user segments extracted from the proposed post Pᵢ that includes U_{i-age}=18-21 and U_{i-location}=CollegeTown. Searching the asset repository for the keywords in set χᵢ yields a set of assets μᵢ that includes an image of a good looking pepperoni pizza and an audio clip of a soda being slurped through a straw, along with other images of other foods such as sandwiches.

Assume that the candidate images selected from the repository are tagged or otherwise associated with at least one of the following keywords: pizza and college. As will be appreciated in light of this disclosure, such keyword indexing and tagging in the asset repository facilitates the candidate asset selection process. In some embodiments, other keywords can be derived from the post as well, such as student, sandwiches, drinks, snacks, dorm food, etc, using known technology such as synonym finders and context analysis tools capable of identifying terms related to the extracted terms. As will be further appreciated in light of this disclosure, associating each stored asset with metadata as provided herein further facilitates the candidate asset ranking process.

For instance, and continuing with the example case, in ranking the candidate assets of set μᵢ, it is found by way of the metadata associated with the pepperoni pizza image that the image was last used three weeks ago on a Sunday night by way of digital marketing channel X (e.g., distribution email list of known college students at Major College), and had a conversion score of 8 (M_{Conversion}=8) in a target audience Aᵢ including both user segments U_{i-age}=18-21 and U_{i-location}=CollegeTown. It is further found that several earlier deployments of the pepperoni pizza image are equally effective in the target audience Aᵢ, except for deployments on Thursday, Friday, and Saturday nights, which have lower conversion rates (M_{Conversion}<4). Assume similar data applies to the audio clip of soda drinking. Further assume that the other candidate assets identified by the asset repository query have relatively lower conversion scores (M_{Conversion}<3) in the target audience Aᵢ by way of the same or other marketing channels. So, in this example scenario, it is clear that students at Major College prefer pizza and soda over other possible food choices available at Mario's. Numerous other scenarios and forms of actionable marketing intelligence will be apparent in light of this disclosure.

As previously explained with respect to Equation 1, and assuming that deployment data is available for the last four deployments, the resulting overall asset score of the pizza image is equal to:

(segment_score_1*asset_performance_score_1)+

(segment_score_2*asset_performance_score_2)+

(segment_score_3*asset_performance_score_3)+

(segment_score_4*asset_performance_score_4),

which equals: (1*8)+(1*8)+(1*7)+(1*9), which equals 32. As similar score can be computed for the audio clip, as well as the other candidate assets identified in the query of the asset repository. This example embodiment assumes that a segment score for a given candidate asset deployment is equal to 1 if that deployment intersected with the target user segments at 100%, and is equal to some fractional number if the intersection with the target user segments is less than 100%. For instance, the segment score might be equal to 0.5 if the given asset deployment intersected 100% with one of two target user segments and 0% with the other target user segment, or partially intersected about 50% with each user segment. The segment score may be zero is there is no intersection. Numerous other suitable segment intersection computations will be apparent in light of this disclosure. Further assume that the performance score for a given candidate asset is the conversion score for that asset, in this example case. If a given candidate asset deployment doesn't have a conversion score, then the performance score for that deployment can be assumed to be zero.

Continuing with the example, the list of ranked assets includes: 1) pizza image; and 2) audio clip of soda drinking. Other lower ranked candidate assets can be listed as well, if so desired. The number of ranked candidate assets presented to the user may be user configuration in some embodiments. In still other embodiments, the top ranked asset or assets are automatically integrated with the proposed post.

User Interface

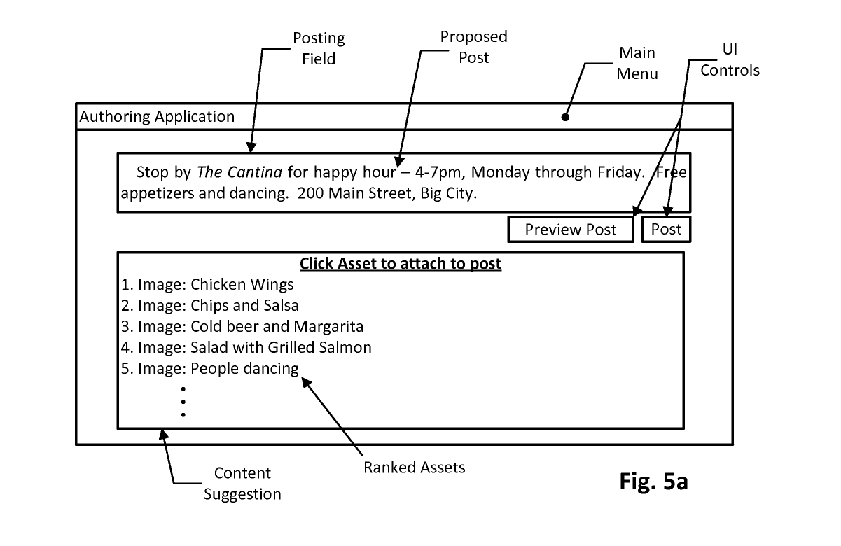

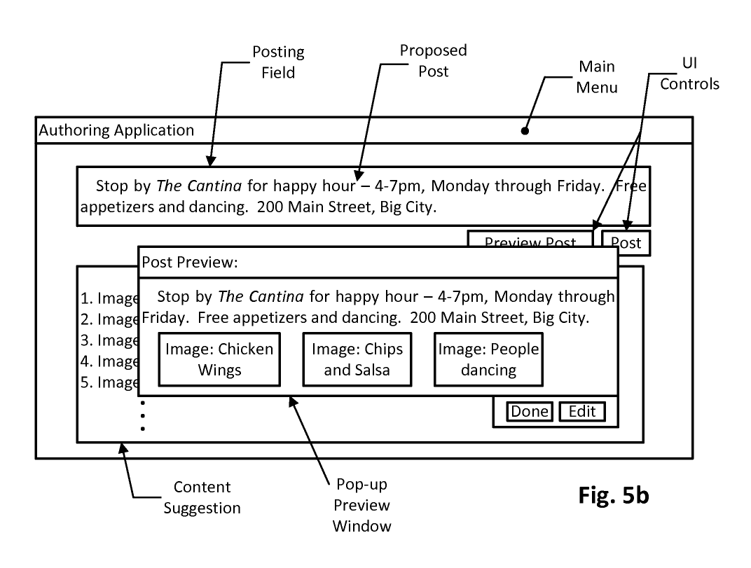

FIG. 5a illustrates one example scenario where the ranked list of candidate assets is presented to the user, in accordance with an embodiment of the present invention. As can be seen, a graphical user interface (GUI) is provided as part of an authoring application, but may also be a stand-alone application (e.g., content suggestion app). In this example case, the UI includes a posting field in which a proposed post can be provided. A post UI control feature is provided for the user to select (e.g., via a mouse click or tap), so as to allow the proposed post to be submitted for publication via some online publishing service (e.g., social network, blog, etc). A preview post UI control feature is also provided, which the user can select to preview the assembled post prior to posting. Also shown is a content suggestion window showing a list of candidate assets suggested for inclusion with the post. In some embodiments, this list of candidate assets is generated in real-time as the user types the proposed post. In other embodiments, the user can first prepare the proposed post and then click or otherwise select a submit UI control feature to have the post analyzed to generate the list of candidate assets. In this example embodiment, the user is prompted to click each of the ranked assets that are desired for attachment or inclusion with the post. Once the user has made those selections, the preview post UI control feature can be selected so as to allow the user to preview the enhanced or otherwise modified post. If the user approves, the modified post can then be published to the desired marketing channel.

FIG. 5b shows one such example embodiment, wherein a pop-up preview window is provided that displays the proposed post and the selected ones of the ranked candidate assets. Once the user is satisfied with the preview, the done UI control feature can be selected to terminate the preview session. If the user wishes to further edit the proposed post, the edit UI control feature can be selected to commence a post edit session, wherein the user can modify text, position and size of rich media assets, and otherwise manipulate the content of the proposed post until satisfied. In some embodiments, the pop-up preview window can be provided automatically in response to the proposed post being submitted for analysis, to give the user one more chance to review and refine the post prior to publication. In some specific embodiments, if the user further modifies the post thereby causing a change in the keywords, a new “re-suggest content assets” UI control feature can be automatically manifested. Alternatively, such further modification can cause the content suggestion process to automatically execute again, to confirm the previously selected assets, or to suggest new assets, as the case may be. Numerous other graphical user interface configurations and use cases, as well as the degree of automation will be apparent in light of this disclosure, and the present disclosure is not intended to be limited to any particular one.

Numerous embodiments will be apparent, and features described herein can be combined in any number of configurations. One example embodiment of the present invention provides a computer implemented method. The method includes receiving a proposed post for publishing to an online community, the post associated with a target audience and a target business metric. The method continues with determining one or more keywords of the post, and determining one or more target user segments of the post, based on the target audience. The method continues with identifying, based on the one or more keywords, one or more candidate assets suitable for inclusion with the post. The candidate assets include at least one of a digital image, graphic, video, and audio file, and each candidate asset is associated with deployment data including, for each deployment, a business metric performance score and one or more user segments. The method continues with ranking each identified candidate asset based on that asset's performance in the one or more target user segments of the target audience, and modifying the proposed post to include at least one of the ranked candidate assets prior to publication of the post. In some cases, the method includes publishing the proposed post as modified by the inclusion of the at least one ranked candidate asset. In some cases, identifying the one or more candidate assets comprises accessing a content repository storing assets and performance data associated therewith. In one such case, the content repository includes deployment data associated with each asset for multiple digital marketing channels. In another such case, the performance data for each asset deployment includes a reach score, an engagement score, and a conversion score. In some cases, ranking each identified candidate asset includes identifying one or more user segments of a candidate asset deployment, assessing an intersection of each user segment of that candidate asset deployment with each of the one or more target user segments of the post, computing a segment score for that candidate asset deployment based on the intersection, and repeating the identifying, assessing, and computing for each deployment of a given candidate asset to provide an overall segment score for that candidate asset. In some cases, ranking each identified candidate asset includes identifying a score of the target business metric for each candidate asset deployment, computing a performance score for each candidate asset based on the deployment scores, and repeating the identifying and computing for each deployment of a given candidate asset to provide an overall performance score for that candidate asset.

Another embodiment of the present invention provides an electronic computing system. The system includes one or more processors that may be local or distributed between local and remote locales. The system further includes a keyword extractor module, executable by the one or more processors, configured to determine one or more keywords of a proposed post for publishing to an online community, the post associated with a target audience and a target business metric. The system further includes a target user segment extractor module, executable by the one or more processors, configured to determine one or more target user segments of the post, based on the target audience. The system further includes an asset selector module, executable by the one or more processors, configured to identify one or more candidate assets suitable for inclusion with the post, based on the one or more keywords. The candidate assets include at least one of a digital image, graphic, video, and audio file, and each candidate asset is associated with deployment data including, for each deployment, a business metric performance score and one or more user segments. The system further includes a ranker module, executable by the one or more processors, configured to rank each identified candidate asset based on that asset's performance in the one or more target user segments of the target audience. The system further includes a module, executable by the one or more processors, configured to modify the proposed post to include at least one of the ranked candidate assets prior to publication of the post. In some cases, the system is further configured to publish the proposed post as modified by the inclusion of the at least one ranked candidate asset. In some cases, the system includes a content repository accessible by the asset selector module and storing assets and performance data associated therewith, wherein the content repository further includes deployment data associated with each asset for multiple digital marketing channels. In some such cases, the performance data for each asset deployment includes a reach score, an engagement score, and a conversion score. In some cases, the ranker module ranks each identified candidate asset by: identifying one or more user segments of a candidate asset deployment; assessing an intersection of each user segment of that candidate asset deployment with each of the one or more target user segments of the post; computing a segment score for that candidate asset deployment based on the intersection; and repeating the identifying, assessing, and computing for each deployment of a given candidate asset to provide an overall segment score for that candidate asset. In some such cases, the ranker module ranks each identified candidate asset by further: identifying a score of the target business metric for each candidate asset deployment; computing a performance score for each candidate asset based on the deployment scores; repeating the identifying and computing for each deployment of a given candidate asset to provide an overall performance score for that candidate asset; and computing a total asset score for each candidate asset based on the overall segment score and the overall performance score of each candidate asset.

Another embodiment of the present invention provides a non-transient computer program product encoded with instructions that when executed by one or more processors causes a process to be carried out. The computer program product may be, for instance, a hard drive, server, disc, thumb-drive, or other suitable non-transient memory or set of memories). The process includes receiving a proposed post for publishing to an online community, the post associated with a target audience and a target business metric. The process continues with determining one or more keywords of the post, and determining one or more target user segments of the post based on the target audience. The process further includes identifying, based on the one or more keywords, one or more candidate assets suitable for inclusion with the post. The candidate assets include at least one of a digital image, graphic, video, and audio file, and each candidate asset is associated with deployment data including, for each deployment, a business metric performance score and one or more user segments. The process further includes ranking each identified candidate asset based on that asset's performance in the one or more target user segments of the target audience, and modifying the proposed post to include at least one of the ranked candidate assets prior to publication of the post. In some cases, the process further includes publishing the proposed post as modified by the inclusion of the at least one ranked candidate asset. In some cases, identifying the one or more candidate assets comprises accessing a content repository storing assets and performance data associated therewith. In some cases, the content repository includes deployment data associated with each asset for multiple digital marketing channels. In some cases, the performance data for each asset deployment includes a reach score, an engagement score, and a conversion score. In some cases, ranking each identified candidate asset includes identifying one or more user segments of a candidate asset deployment; assessing an intersection of each user segment of that candidate asset deployment with each of the one or more target user segments of the post; computing a segment score for that candidate asset deployment based on the intersection; and repeating the identifying, assessing, and computing for each deployment of a given candidate asset to provide an overall segment score for that candidate asset. In some such cases, ranking each identified candidate asset further includes identifying a score of the target business metric for each candidate asset deployment; computing a performance score for each candidate asset based on the deployment scores; and repeating the identifying and computing for each deployment of a given candidate asset to provide an overall performance score for that candidate asset.

The foregoing description of example embodiments of the invention has been presented for the purposes of illustration and description. It is not intended to be exhaustive or to limit the invention to the precise forms disclosed. Many modifications and variations are possible in light of this disclosure. It is intended that the scope of the invention be limited not by this detailed description, but rather by the claims appended hereto.

What is claimed is:

1. A computer implemented method, comprising:
receiving a proposed post for publishing to an online community, the post associated with a target audience and a target business metric;
determining one or more keywords of the post;
determining one or more target user segments of the post, based on the target audience;
identifying, based on the one or more keywords, one or more candidate assets suitable for inclusion with the post, the candidate assets including at least one of a digital image, graphic, video, and audio file, wherein each candidate asset is associated with deployment data including, for each deployment, a business metric performance score and one or more user segments;
ranking each identified candidate asset based on that asset's performance in the one or more target user segments of the target audience; and
modifying the proposed post to include at least one of the ranked candidate assets prior to publication of the post.

2. The method of claim 1 further comprising publishing the proposed post as modified by the inclusion of the at least one ranked candidate asset.

3. The method of claim 1 wherein identifying the one or more candidate assets comprises accessing a content repository storing assets and performance data associated therewith.

4. The method of claim 3 wherein the content repository includes deployment data associated with each asset for multiple digital marketing channels.

5. The method of claim 3 wherein the performance data for each asset deployment includes a reach score, an engagement score, and a conversion score.

6. The method of claim 1 wherein ranking each identified candidate asset comprises:
identifying one or more user segments of a candidate asset deployment;
assessing an intersection of each user segment of that candidate asset deployment with each of the one or more target user segments of the post;
computing a segment score for that candidate asset deployment based on the intersection; and
repeating the identifying, assessing, and computing for each deployment of a given candidate asset to provide an overall segment score for that candidate asset.

7. The method of claim 1 wherein ranking each identified candidate asset comprises:
identifying a score of the target business metric for each candidate asset deployment;
computing a performance score for each candidate asset based on the deployment scores; and
repeating the identifying and computing for each deployment of a given candidate asset to provide an overall performance score for that candidate asset.

8. An electronic computing system, comprising:
one or more processors;
a keyword extractor module, executable by the one or more processors, configured to determine one or more keywords of a proposed post for publishing to an online community, the post associated with a target audience and a target business metric;
a target user segment extractor module, executable by the one or more processors, configured to determine one or more target user segments of the post, based on the target audience;
an asset selector module, executable by the one or more processors, configured to identify one or more candidate assets suitable for inclusion with the post, based on the one or more keywords, the candidate assets including at least one of a digital image, graphic, video, and audio file, wherein each candidate asset is associated with deployment data including, for each deployment, a business metric performance score and one or more user segments;
a ranker module, executable by the one or more processors, configured to rank each identified candidate asset based on that asset's performance in the one or more target user segments of the target audience; and
a module, executable by the one or more processors, configured to modify the proposed post to include at least one of the ranked candidate assets prior to publication of the post.

9. The system of claim 8 wherein the system is further configured to publish the proposed post as modified by the inclusion of the at least one ranked candidate asset.

10. The system of claim 8 further comprising a content repository accessible by the asset selector module and storing assets and performance data associated therewith, wherein the content repository further includes deployment data associated with each asset for multiple digital marketing channels.

11. The system of claim 10 wherein the performance data for each deployment includes a reach score, an engagement score, and a conversion score.

12. The system of claim 8 wherein the ranker module ranks each identified candidate asset by:
identifying one or more user segments of a candidate asset deployment;
assessing an intersection of each user segment of that candidate asset deployment with each of the one or more target user segments of the post;
computing a segment score for that candidate asset deployment based on the intersection; and
repeating the identifying, assessing, and computing for each deployment of a given candidate asset to provide an overall segment score for that candidate asset;

13. The system of claim 12 wherein the ranker module ranks each identified candidate asset by further:
identifying a score of the target business metric for each candidate asset deployment;
computing a performance score for each candidate asset based on the deployment scores;
repeating the identifying and computing for each deployment of a given candidate asset to provide an overall performance score for that candidate asset; and.
computing a total asset score for each candidate asset based on the overall segment score and the overall performance score of each candidate asset.

14. A non-transient computer program product encoded with instructions that when executed by one or more processors causes a process to be carried out, the process comprising:
receiving a proposed post for publishing to an online community, the post associated with a target audience and a target business metric;
determining one or more keywords of the post;
determining one or more target user segments of the post, based on the target audience;
identifying, based on the one or more keywords, one or more candidate assets suitable for inclusion with the post, the candidate assets including at least one of a digital image, graphic, video, and audio file, wherein each candidate asset is associated with deployment data including, for each deployment, a business metric performance score and one or more user segments;
ranking each identified candidate asset based on that asset's performance in the one or more target user segments of the target audience; and
modifying the proposed post to include at least one of the ranked candidate assets prior to publication of the post.

15. The computer program product of claim 14, the process further comprising publishing the proposed post as modified by the inclusion of the at least one ranked candidate asset.

16. The computer program product of claim 14 wherein identifying the one or more candidate assets comprises accessing a content repository storing assets and performance data associated therewith.

17. The computer program product of claim 16 wherein the content repository includes deployment data associated with each asset for multiple digital marketing channels.

18. The computer program product of claim 16 wherein the performance data for each asset deployment includes a reach score, an engagement score, and a conversion score.

19. The computer program product of claim 14 wherein ranking each identified candidate asset comprises:
identifying one or more user segments of a candidate asset deployment;
assessing an intersection of each user segment of that candidate asset deployment with each of the one or more target user segments of the post;
computing a segment score for that candidate asset deployment based on the intersection; and
repeating the identifying, assessing, and computing for each deployment of a given candidate asset to provide an overall segment score for that candidate asset.

20. The computer program product of claim 19 wherein ranking each identified candidate asset further comprises:
identifying a score of the target business metric for each candidate asset deployment;
computing a performance score for each candidate asset based on the deployment scores; and
repeating the identifying and computing for each deployment of a given candidate asset to provide an overall performance score for that candidate asset.
